(19) United States
(12) Patent Application Publication
(10) Pub. No.: US 2007/0173261 A1
(43) Pub. Date: Jul. 26, 2007

(54) Predetermined transmission mode sequence and feedback reduction technique

(75) Inventors: Paolo Priotti, Torino (IT); Kodo Shu, Kawasaki-shi (JP); Tsuyoshi Kashima, Yokohama-shi (JP)

Correspondence Address: FOLEY & LARDNER LLP, P.O. BOX 80278, SAN DIEGO, CA, 92138-0278, US

(73) Assignee: Nokia Corporation

(21) Appl. No.: 11/340,348

(22) Filed: Jan. 26, 2006

(51) Int. Cl. H04Q 7/20

(52) U.S. Cl. 455/450

(57) ABSTRACT

A system for using a predetermined sequence of transmission modes together with power sequencing in order to reduce signaling while improving SNIR levels. Each sequence comprises a vector of transmission modes, where each mode can include a signal constellation, a concatenated channel coding type and rate and, for multiple-input multiple-output systems, one type of matrix modulation. Base transceiver stations can estimate the interference condition for each piece of user equipment and, based on this information, will preferably decide an optimal sequence for each item of user equipment.

### FIELD OF THE INVENTION

The present invention relates generally to the field of wireless transmission. More particularly, the present invention relates to the use of broadband multicarrier transmission links in wireless communication.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

In a wireless communication system, a mobile station is enabled to communicate with an access station of a wireless communication network by means of a connection via a radio interface.

The radio resources, which are available for a particular wireless communication system, can be used in different simultaneous connections without interference by splitting the radio resources up into different channels.

For example, in Frequency Division Multiple Access (FDMA), different frequencies are employed for different connections. In Time Division Multiple Access (TDMA), available radio resources are divided into frames, each frame comprising a predetermined number of time-slots. To each connection, a different time-slot may then be assigned in each frame. In Code Division Multiple Access (CDMA), different codes are used in different connections for spreading the data over the bandwidth.

A wireless communication system typically comprises a plurality of fixed stations as access stations, each enabling a communication with mobile stations located in one or more sub-areas served by the fixed station. A sub-area can be for instance a cell of a cellular communication system or a sector of a sectorized wireless communication system. It is to be understood that in case reference is made to a cell in the following, the same applies to a sector.

Using a plurality of cells allows reusing the same channels in various cells. In this case, however, it has to be ensured that interference is kept sufficiently low not only within a respective cell, but also between different cells of the system.

In cellular FDMA/TDMA systems, intra-cell interference is minimized by transmitting signals at different time-slots and/or at different frequency channels in the same cells. Inter-cell interference is managed by defining a co-channel reuse distance. That is, the same time-slots/frequencies are only used by cells having a certain reuse distance to each other, the reuse distance being selected such that the co-channel interference between these cells is reduced sufficiently by the path loss of transmitted signals. However, in order to exploit the available radio resources optimally or avoid excessive usage of bandwidth, a low frequency-reuse, that is, a very small reuse distance, may be preferred in a FDMA/TDMA system. A small reuse distance may lead to severe inter-cell interference, in particular at the cell edges. In this case, a smart Radio Resource Management (RRM) is essential for keeping inter-cell interference at an acceptable level.

In cellular CDMA systems, intra-cell interference is reduced by orthogonal codes, for example at the downlink. Inter-cell interference is relieved by scrambling codes. However, in some situations, for instance in case of high-data-rate users at the cell edges, the inter-cell interference still becomes strong and there is no mechanism available to control the interference in a multi-cell environment.

For cellular systems having low frequency reuse, which implies that the same frequency is reused in cells close to each other, inter-cell interference, or co-channel interference if the same frequency channel is used, is thus a critical issue.

In U.S. Pat. No. 6,259,685, it has been proposed to optimize a network interference level by blocking in relation to time the transmission powers to be used. First, carrier frequencies are allocated to cells with a relatively dense reuse pattern. The cells using the same carrier frequencies are then divided into classes. In each class, the transmission powers of cells belonging to the same class and using the same channel on a time-slot basis is adjusted, so that each cell has an individual time-slot basis transmission power limitation and that, concerning each time-slot, a transmission at the maximum transmission power is allowed only in one cell.

It has further been proposed for non-CDMA type systems that transmissions at high powers in different cells are shifted to different timings. Transmissions at high powers can be used for example for transmission of time-slot, pilot and system information blocks. Due to such a time-shift in a low frequency-reuse environment, inter-cell interference can be managed so that worst interference situations, resulting from simultaneous transmissions at peak power in different cells, can be avoided.

For cellular networks with low or unitary frequency reuse and without signal spreading, to alleviate the problem of intercell interference degrading transmission performance and creating out-of-service conditions for user equipment at a cell edge or in other locations having low signal to noise interference ratios (SNIR), particularly in the case of high network load, the use of power sequences has been previously proposed.

The use of power sequences can help to prevent users at cell edges or in other low-SNIR locations from being locked out of their network in high load conditions. The use of power sequences therefore guarantees that all users have a minimum SNIR for at least a certain period of time. However, when power sequences are adopted in a network, the network produces a fluctuating SNIR condition. In order to achieve a maximum throughput in such a condition, adaptive modulation and coding (AMC) becomes necessary.

In an ideal situation, for each user and for each “step” of the power sequence, a base transceiver station (BTS) adapts the transmission mode to maximize the throughput. If the power sequence has a relatively short duration for each step, however, such an adaptation mechanism can lead to a substantial amount of signaling. When operating in a down-link or over an orthogonal frequency division multiplexing (OFDM) link, in the case where one step of the power sequence lasts between one and a few OFDM symbols (assuming that decoding is not blind, but is instead based on feedforward AMC information), down-link signaling should carry the transmission for each subcarrier for each step. However, this amount of signaling can be impractical and therefore, it is desirable to reduce the amount of signaling.

### SUMMARY OF THE INVENTION

The present invention involves the use of a predetermined sequence of transmission modes to be performed together with the power sequence discussed above. Each sequence comprises a vector of transmission modes, where each mode can include a signal constellation, a concatenated channel coding type and rate and, for multiple-input multiple-output (MIMO) systems, one type of matrix modulation. Base transceiver stations (BTSs) can estimate the interference condition for each user equipment (UE) and, based on this information, will preferably decide an optimal sequence for each UE. In particular, for multi-carrier MIMO systems an adaptation and signaling scheme have been previously proposed, where the subcarriers can be grouped into clusters and, for each cluster, one of two possible transmission modes are selected via a single bit. The present invention involves the embedding of this type adaptation and signaling mechanism in the network, such that every transmission mode in a sequence can just be one of two possible modes.

The present invention also involves the extension of such adaptation and signaling method: out of the set of possible sequences built up using two transmission modes. The BTS will select an optimal or sub-optimal subset of sequences for every UE. The BTS will then select, with a few bits, what sequence is used for each cluster of subcarriers. The amount of signaling will such be substantially reduced, as the transmission mode sequence is selected only at the beginning of the power sequence. Additionally, a new transmission mode does not need to be signaled for each new step of the power sequence. In case the set of sequences used for a given UE is limited to two, the signaling to be performed at the beginning of a power sequence will be limited to one bit per cluster of subcarriers (apart from a limited number of bits always necessary to indicate the two constituent transmission modes and the two sequences). With the present invention, an increased throughput is achieved relative to non-adaptive systems as a result of the reduced quantity of signaling.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a schematic diagram of a wireless communication system;

FIG. 2 is a flow chart illustrating an assignment of DL transmission power in the system of FIG. 1;

FIG. 3 presents diagrams illustrating “orthogonal” power sequences assigned to different cells in the system of FIG. 1;

FIG. 4 presents diagrams illustrating a prediction of C/I ratios for different time-slots in the system of FIG. 1;

FIG. 5 is a mapping table used in the system of FIG. 1 for determining a target C/I;

FIG. 6 is a flow chart illustrating an assignment of UL transmission power in the system of FIG. 1;

FIG. 7 is a depiction showing an example operation of a downlink adaptation sequence according to one embodiment of the present invention;

FIG. 8 is a perspective view of a mobile telephone that can be used in the implementation of the present invention; and

FIG. 9 is a schematic representation of the telephone circuitry of the mobile telephone of FIG. 8.

### DETAILED DESCRIPTION OF THE PREFERRED EMBODIMENTS

The present invention involves the use of a predetermined sequence of transmission modes to be performed together with the power sequence discussed above. Each sequence comprises a vector of transmission modes, where each mode can include a signal constellation, a concatenated channel coding type and rate and, for multiple-input multiple-output (MIMO) systems, one type of matrix modulation. Base transceiver stations (BTSs) can estimate the interference condition for each user equipment (UE) and, based on this information, will preferably decide an optimal sequence for each UE. In particular, for multi-carrier MIMO systems an adaptation and signaling scheme have been previously proposed, where the subcarriers can be grouped into clusters and, for each cluster, one of two possible transmission modes are selected via a single bit. The present invention involves the embedding of this type adaptation and signaling mechanism in the network, such that every transmission mode in a sequence can just be one of two possible modes.

The present invention also involves the extension of such adaptation and signaling method: out of the set of possible sequences built up using two transmission modes. The BTS will select an optimal or sub-optimal subset of sequences for every UE. The BTS will then select, with a few bits, what sequence is used for each cluster of subcarriers. The amount of signaling will such be substantially reduced, as the transmission mode sequence is selected only at the beginning of the power sequence. Additionally, a new transmission mode does not need to be signaled for each new step of the power sequence. In case the set of sequences used for a given UE is limited to two, the signaling to be performed at the beginning of a power sequence will be limited to one bit per cluster of subcarriers (apart from a limited number of bits always necessary to indicate the two constituent transmission modes and the two sequences). With the present invention, an increased throughput is achieved relative to non-adaptive systems as a result of the reduced quantity of signaling.

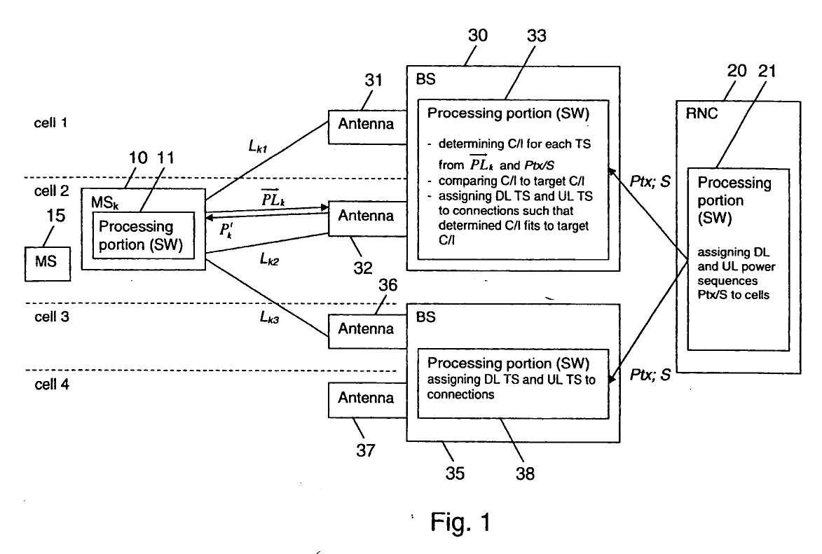

The following is a general discussion of power sequences, which can be used in conjunction with the predetermined sequence of transmission modes of the present invention. FIG. 1 is a schematic diagram of a wireless communication system, which allows an allocation of time-slots for downlink and uplink connections. It should be noted that the following explanation of a power sequencing may be based on its application on time domains. However, the method of power sequencing can also be extended to other radio resources such as frequency, beam-patterns, etc. In other words, time slots in the following section can refer to frequency chunks if applying the power sequence to a frequency domain. The wireless communication system is by way of example a 3G mobile communication system. The wireless communication system comprises a mobile communication network and a plurality of mobile stations 10, 15, two of which are depicted. The mobile communication network includes a radio access network (RAN) with an RNC 20 and a plurality of base stations 30, 35, two of which are depicted. Each base station 30, 35 may serve one or more cells. This is indicated in FIG. 1 by a first group of antennas 31 associated to the first base station 30 for serving a first cell, a second group of antennas 32 associated to the first base station 30 for serving a second cell, a first group of antennas 36 associated to the second base station 35 for serving a third cell, and a second group of antennas 37 associated to the second base station 35 for serving a fourth cell. The base stations 30, 35 are mutually time-synchronized.

FIG. 1, mobile stations 10, 15 are shown to be located in the second cell served by the second group of antennas 32 of the first base station 30. The mobile stations 10, 15, the RNC 20 and the base stations 30, 35 all comprise a respective processing portion 11, 21, 33, 38 supporting the allocation of time-slots. The processing portions 33, 38 of the base stations form packet schedulers. The support may be implemented in each of the processing portions 11, 21, 33, 38 by software.

For each mobile station 10, 15 one of the base stations 30 is the serving base station, usually the one from which the strongest signals can be received. A mobile station 10 may access the cellular communication network via this serving base station 30.

Each communication between a mobile station 10 and a base station 30 is based on time frames. For a downlink connection enabling a data transmission from the base station 30 to the mobile station 10, a time-slot in a downlink time frame has to be selected and a transmission power has to be determined which is to be used by the base station 30 for transmissions in this downlink time-slot. For an uplink connection enabling a data transmission from a mobile station 10 to a base station 30, a time-slot in an uplink time frame has to be selected and a transmission power has to be determined which is to be used by the mobile station 10 for transmissions in this uplink time-slot.

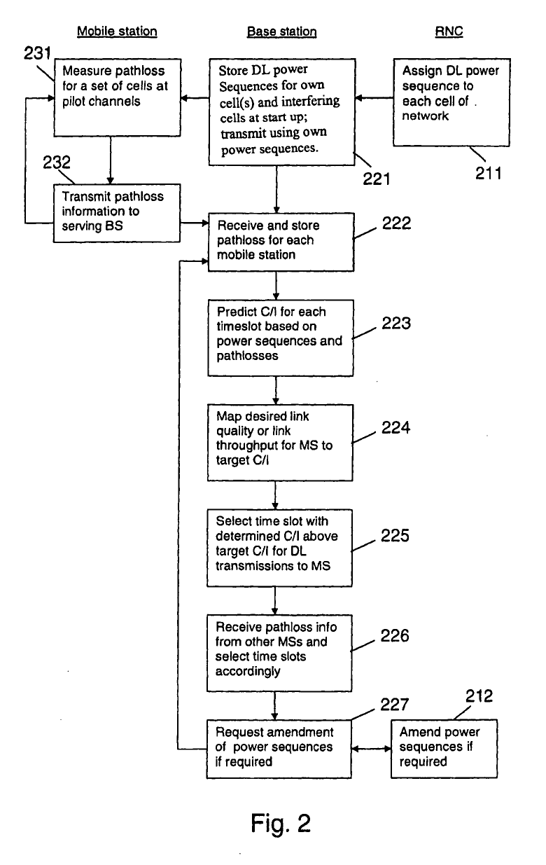

An operation in the system of FIG. 1 for assigning downlink time-slots and transmission powers for transmissions to a respective mobile station 10 is illustrated in the flow chart of FIG. 2. FIG. 2 presents on the left hand side the operation by the processing portion 11 of a mobile station 10, in the middle the operation by the processing portion 33 of a base station 30 and on the right hand side the operation by the processing portion 21 of the RNC 20. The RNC 20 assigns a pre-determined downlink power sequence to each cell served by a base station 30, 35 connected to the RNC 20. (step 211)

A downlink power sequence consists of a series of power levels Ptx at a base station should transmit in a respective cell in the defined order. The power sequences indicate a power level only for those time-slots carrying payload data for individual users.

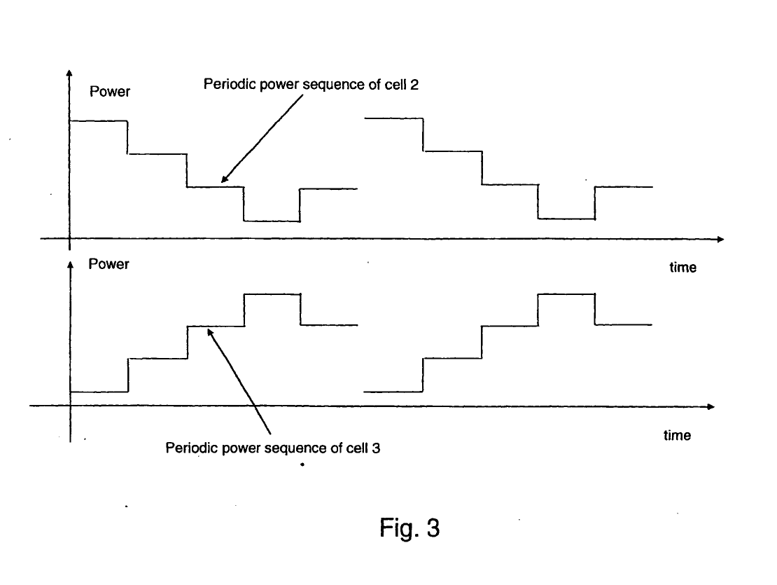

Exemplary power sequences for two cells are indicated in the diagrams of FIG. 3. At the top, a diagram shows a power sequence associated to a first cell over time. The power sequence is repeated periodically. At the bottom, a diagram shows a power sequence associated to a second cell over time. The power sequence is repeated periodically. Ideally, every cell should employ a power sequence, which is “orthogonal to neighboring or interfering cells. The “orthogonality” implies roughly that any two interfering cells will not use high transmission powers simultaneously, as in the case of the two power sequences shown in FIG. 3.

The power sequence associated to one cell can be reused in another non-interfering cell. When a new base station is installed, the cells served by it are assigned as well a respective power-sequence that is orthogonal to the neighboring cells. To this end, the group of available power sequences has enough members to allow network extensions without the need to re-assign all power sequences for existing base stations 30, 35 in the network. This feature eases the difficulty in network planning.

At the startup of a base station 30, the RNC 20 provides the base station 30 with the downlink power sequences, which have been assigned to the cells of the base station 30 itself, and the power sequences, which have been assigned to interfering cells. The base station 30 stores the received power sequences for further use. In addition, the base station 30 may broadcast its own downlink power sequences as system information in a broadcast channel for facilitating a channel estimation at the mobile stations 10, 15. (step 221)

Each mobile station 10, 15 of the cellular communication system measures at regular intervals the paths on pilot channels for all cells, from which it is able to receive the pilot signals (step 231). The path loss information is updated frequently, the updating frequency affecting the accuracy of the presented algorithm. The updating frequency should at least track the variation of slow fading. Path loss is to be understood here to consist of the normal distance- and frequency-dependent path loss and of losses due to shadowing.

In each cell of the cellular communication system, respectively one of the mobile stations 10 transmits the measured path loss information to its serving base station 30 (step 232). The serving base station 30 is the base station making scheduling decisions for the mobile station 10. Typically, it is the base station with the highest received power or the lowest path loss on the pilot channel. The path loss information includes a path loss vector \vec{PLₖ}=[Lₖ₁, Lₖ₂, . . . Lₖₙ], where Lₖₓ, represents the measured path loss between cell x and mobile station k MSₖ. In FIG. 1, by way of example the path losses Lₖ₁, Lₖ₂, Lₖ₃ measured at mobile station 10 for pilot channels from the first, the second and the third cell is indicated, and moreover the resulting path loss vector \vec{PLₖ}, which is provided to base station 30 is indicated.

The serving base station 30 receives and stores the received path loss vector from a respective mobile station 10. (step 222) From this path loss vector, the base station 30 knows which cells of the system will be interfering cells for a mobile station 10 it is serving. Based on the stored path loss vector and the downlink stored power sequences, the base station 30 then predicts for the mobile station 10 the C/(I+N) for each time-slot t of a frame. (step 223)

The stored power-sequences indicate the transmission power levels which all cells will use at a certain time-slot t. In interference-limited systems, Moreover, the interference I is much larger than the noise N. Therefore, the C/(I+N) at mobile station k for signals transmitted by the i^{th} base station 30 at time-slot t can be expressed as follows:

$${( C / I + N )}_{k}^{t} = {( \frac{C}{I} )}_{k}^{t} = \frac{{Ptx}_{i}^{t} / {L}_{ki}}{{Ptx}_{1}^{t} / {L}_{k 1} + {Ptx}_{2}^{t} / {L}_{k 2} + ⋯ + {Ptx}_{n}^{t} / {L}_{kn}}$$

where Ptxᵢ^{t}/Lₖᵢ is not included in the sum Ptx₁^{t}/Lₖ₁+Ptx₂^{t}/Lₖ₂+ . . . +Ptxₙ^{t}/Lₖₙ.

Ptxᵢ ^{t} is the transmission power level employed by the base station 30 for time-slot t in the second cell in accordance with the associated power sequence, and Ptx₁^{t}, Ptx₂^{t}, . . . Ptxₙ^{t} are transmission power levels employed for time-slot t in the interfering cells in accordance with the respectively associated power sequence.

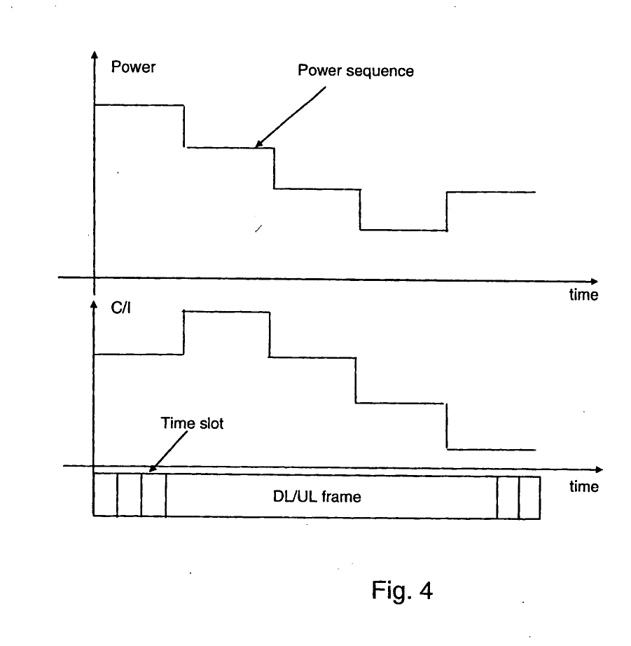

An exemplary predicted C/I is illustrated in FIG. 4. At the bottom, FIG. 4 shows a representation of a frame comprising a plurality of time-slots. At the top, a diagram shows a power sequence associated to the second cell over time, similarly as the diagram at the top of FIG. 3. It can be seen that, in this example, the power sequence associates the same power level to a respective group of four consecutive time-slots. In the middle, a diagram shows the predicted C/I over time for the second cell to which the power sequence at the top is associated. While the variations in the carrier value C depend on the variations of the downlink transmission power employed in the current cell in accordance with the associated power sequence, the interference value I depends on the variation of the downlink transmission power employed in all interfering cells in accordance with the respectively associated power sequence. Therefore, the C/I variation over time differs from the downlink transmission power variation over time.

The predicted

$${( \frac{C}{I} )}_{k}^{t}$$

for each time-slot t is related to the link performance or the link throughput that can be expected at a certain time-slot for mobile station k. Therefore, the base station 30 maps in addition a required link performance or link throughput to a target C/I for mobile station k, referred to as

$${}^{′} {( \frac{C}{I} )}_{k}^{Target}$$

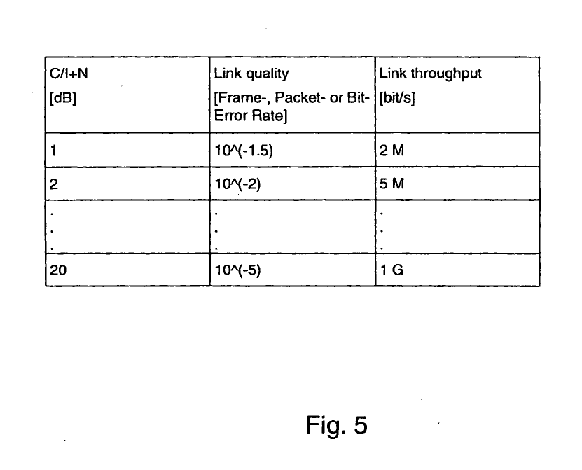

(step 224). The mapping can be performed by means of a mapping table which associates a target C/I or C/I+N value in dB to a required link performance and/or to a required link throughput. The required link performance can be indicated for example by a maximum frame error rate, a maximum packet error rate or a maximum bit error rate, while the required link throughput can be indicated for example in minimum bit/s (bit per second). An exemplary mapping table is represented in FIG. 5. The table can be generated for instance from link-level simulation results or field measurements. It should also be noted that this table can also include, as variables, the modulation and forward coding that are used.

The base station 30 now selects the time-slot t that results in an adequate C/I for the currently considered mobile station k with the smallest margin, that is, the time-slot t, for which

$${η}_{k}^{KL} ( t ) = {( \frac{C}{I} )}_{k}^{Target} / {( \frac{C}{I} )}_{k}^{t} \leq 1$$

is closest to unity. (step 225)

The base station 30 may then transmit packets to the mobile station 10 in the selected time-slot t using the transmission power associated by the downlink power sequence for the second cell to this time-slot. The same process described with reference to steps 222 to 225 of FIG. 2 is carried out for all other mobile stations 15 in the cell for which there is data in queue. (step 226) Further, the process is repeated at regular intervals for all mobile stations 10, 15. The length of the intervals may depend, for example, on the frequency at which the mobile stations 10, 15 measure the required path losses. Alternatively, it may also be repeated much more frequently than the measurement of the path losses, for example in each frame, which may last less than one millisecond.

By knowing the link throughput, that is, the achievable capacity, beforehand, the base station 30 can thus schedule packet transmissions such that capacity-requests (CR) in the queue for a served cell will be optimally ordered and served according to the achievable capacity. Furthermore, an optimal scheduling decision can be made to maximize the cell throughput.

It has to be noted that a power sequence only limits the maximum transmission power that can be used by a base station for a particular cell in a given time-slot. Nothing prevents the base station from using a lower transmission power if a sufficiently high C/I can still be obtained. This is safe to do as the estimate of the interference I is always an overestimate, because it is based on maximum allowed values. However, lowering the transmission power from the maximum allowed value leads to a waste of radio resources in the network, because the scheduling in a given cell is based on the predicted maximum interference from the interfering cells. Therefore, the above defined value ηₖ^{KL} can be understood as a figure of merit for the goodness of scheduling for mobile station k. As an example, if all mobile stations were scheduled with a value of η=0.5, at most 50% of the network capacity could be obtained. Any extra power margin should therefore be used instead to increase the information rate by a link adaption.

If required, the stored power sequences can also be amended upon request by a base station 30, 35 (step 227). In case there are certain mobile stations 15 near an edge of the cell which have a high traffic-volume, for example, the serving base station 30 may be enabled to change the power sequence associated to the cell such that the average transmission power for the cell increases. One possibility for enabling a change of assigned power sequences is that selected time-slots are defined as “wild-card” time-slots and set beforehand to a low power value in all power sequences. A base station 30, 35 can then assign a high power value to such a wild-card time-slot by a reservation scheme.

On the whole, only when one of the base stations 30, 35 changes a power sequence associated to one of its cells, for example to respond adaptively to a change in the load conditions, a communication between the base stations 30, 35 (or a communication involving the RNC 20) is needed in order to update the stored power sequences for interfering cells. Hence the amount of signaling flow between base stations is expected to be minimal.

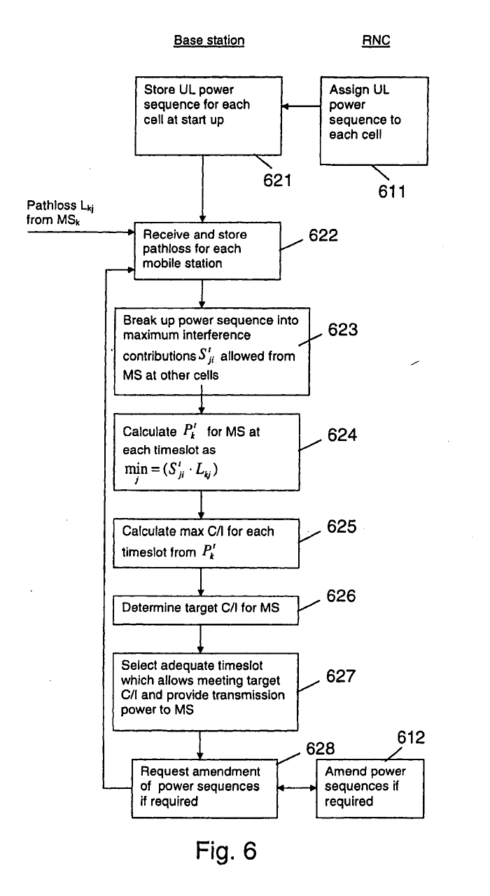

The assignment of a time-slot t to an uplink connection is a modification of the described assignment of a time-slot t to a downlink connection, which will be described in the following with reference to the flow chart of FIG. 6.

FIG. 6 presents on the left hand side the operation by the processing portion 33 of a base station 30 and on the right hand side the operation by the processing portion 21 of the RNC 20. The RNC 20 assigns a pre-determined uplink power sequence to each cell, which may be different from the downlink power sequence assigned to the same cell. (step 611)

In the uplink case, a power sequence does not limit any transmission powers in the cell to which it is assigned, though. Instead, an uplink power sequence consists of a series of received power levels S that limit for a respective time-slot t the maximum uplink interference power a base station 30 shall receive in a serving cell from all interfering cells. The uplink power sequences associated to interfering cells should equally be “orthogonal” to each other.

The path losses between a respective mobile station 10, 15 and various base stations 30, 35 are known from the measurements carried out by the mobile stations 10, 15 in step 231 of FIG. 2 for the downlink transmissions. Therefore, the corresponding operation in the mobile station 10, 15 is not indicated again, but only the reception and storage of the path loss for each mobile station. (step 622) It is to be understood that the reception and storage are required only once, thus step 222 of FIG. 2 and step 622 of FIG. 6 are actually the same step.

The uplink power sequence for a cell i, in the present example the second cell in FIG. 1, can be written as , where Sᵢ^{t} is the uplink power level for the i^{th} time-slot in cell i. S, is now broken up into interference contributions from all interfering cells Sᵢⱼ^{t}=γᵢⱼSᵢ^{t} where Sᵢⱼ^{t} is the maximum allowed uplink interference power received in cell i from cell j (step 623). γᵢⱼ is independent of the time-slots and is known by the base station 30. The value of γᵢⱼ is agreed upon by the base stations 30, 35 serving respective cells i and j based on a long-term interference monitoring and determined more specifically in the RNC 20. The values are selected such that Σγᵢⱼ=1 for a respective cell i.

Next, the base station 30 serving cell i calculates the maximum allowed transmission power Pₖ^{t} for a mobile station k, in the present example mobile station 10, for all time-slots, time-slot t being used as an example. The transmission power Pₖ^{t} is calculated from the condition that the uplink interference power received at any cell j from cell i shall not exceed Sᵢⱼ^{t}:

$${P}_{k}^{t} = {min}_{j} ( {S}_{ji}^{t} \cdot {L}_{kj}^{t} ) = {min}_{j} ( {γ}_{ji} \cdot {S}_{j}^{t} \cdot {L}_{kj}^{t} )$$

where Lₖⱼ represents the path-loss from mobile station k to cell j, as indicated above. The serving cell is naturally omitted from the minimum calculation. (step 624)

Finally, the base station 30 serving cell i can now calculate for mobile station k the maximum achievable C/IIiNI for each uplink time-slot t as:

$${( C / I + N )}_{k}^{t} = {( \frac{C}{I} )}_{k}^{t} = \frac{{Ptx}_{i}^{t} / {L}_{ki}}{{Ptx}_{1}^{t} / {L}_{k 1} + {Ptx}_{2}^{t} / {L}_{k 2} + ⋯ + {Ptx}_{n}^{t} / {L}_{kn}}$$

Noise N is assumed again to be much smaller than interference I. (step 625)

Further, the base station 30 determines a target C/I for mobile station k for each time-slot t (step 626).

The base station 30 can now calculate from the target C/I a figure of merit qr(t) for scheduling uplink transmissions by mobile station k to a particular time-slot t:

$${η}_{k}^{UL} ( t ) ≡ \frac{{\sum }_{j} {P}_{k}^{t} / {L}_{kj}}{{\sum }_{j} {γ}_{ji} \cdot {S}_{j}^{t}} , {( \frac{C}{I} )}_{k}^{Target} / {( \frac{C}{I} )}_{k}^{t} \leq 1$$

The figure of merit is similar to the figure of merit in the downlink case, but it has an additional multiplier that accounts for how much of the allocated interference budget cell i is able to use. The summations for the additional multiplier go over those cells j for which γⱼᵢ≠0. The closer the figure of merit is to unity, the better will be the usage of the network radio resources. For each mobile station k in cell i, the base station 30 thus selects the time-slot t that results in an adequate C/I, that is, the C/I with the highest value of Θₖ^{UL} below one. The time-slot t selected for mobile station k and the maximum transmission power Pₖ^{t} calculated in step 624 for mobile station k and this time-slot t are transmitted to the respective mobile station k. (step 627)

The mobile station 10 may then transmit packets to the base station 30 in the selected time-slot t using the indicated transmission power Pₖ^{t}. The uplink power sequences may be amended if required. (step 628) in cooperation between the base stations 30, 35 via the RNC 20 (step 612). The same process described with reference to steps 622 to 627 of FIG. 6 is carried out for all other mobile stations 15 in the cell for which there is data in queue (not shown).

With the operations presented with reference to FIGS. 2 and 6, thus only the downlink and uplink power sequences have to be communicated at a start up from the RNC 20 to the base stations 30, 35 for allocating suitable timeslots and transmission powers to downlink and uplink connections. No further signaling is needed in the network, unless the power sequences are to be changed. In addition, only the path loss measurements made by the mobile terminals 10, 15 are required at the base stations 30.

In the following, some possibilities of amending the power sequences and of optimizing the time-slot allocation will be dealt with in more detail.

In a high load situation, the assigned power sequences offer time-slots for each cell in which the interference level from other cells is low and the cell itself can use higher powers. A base station 30 uses such time-slots for mobile stations 10, 15 requiring a high C/I or for those mobile stations 10, 15 that are far away from the base station 30. If there are not enough such time-slots permitting a high transmission power available for a cell, the queue starts growing. If the queue for one cell gets much longer than those of surrounding cells, the serving base station 30 could negotiate with the other base stations 35 or the RNC 20 to adopt a power sequence that is more suitable for serving such mobile stations, or use the proposed reservation mechanism. This would not lead to a large amount of signaling, because these are much longer-term adaptations than the typical scheduling cycle. If all cells have growing queues, this implies a network overload situation.

In low load situation, the allocated power sequences could have a plurality of “wild-card time-slots, that is, time-slots with a low value in all download power sequences and a high value in all uplink power sequences. The base station could then reserve” one of these time-slots for longer periods of time. The reservation of downlink wild-card time-slots happens by obtaining a high transmission power permit for that slot. In the uplink, reserving a “wild-card” time-slot would mean obtaining a low reception interference power allowance. In such cases, it might frequently happen that the cell is not able to fulfill the interference budget given to it, but this situation is acceptable when the load is low.

When the network load grows, the network could then start allocating power sequences with less and less wild-card time-slots. All these are statistical changes with low signaling load among the base stations.

For further improving the time-slot allocation, a base station can moreover optimally shuffle the order of capacity requests based on a predicted C/I at each time-slot so that the achievable throughput is maximized. For example, in case two time-slots have to be allocated to two mobile stations, the values of a figure of merit could be 0.5 and 0.6, respectively, for the time-slots for mobile station 1 and 0.2 and 0.9, respectively, for the time-slots for mobile station 2. Without optimization, mobile station 1 might simply chooses a time-slot first. In this case, the first time slot will be allocated to mobile station 2 and the second time-slot will be allocated to mobile station 1, although it might be a mare optimal order to allocate the first time-slot to mobile station 1 and the second time-slot to mobile station 2.

A more optimized distribution could be achieved in several ways. In a first approach, for example, the highest ratio is chosen first. In the above example, this means that first, the 0.9 time-slot is chosen for mobile station 2. In a second approach, the minimum ratio of all users is maximized. In the above example, this means that selecting the 0.5 time-slot for mobile station 1 is better than selecting the 0.2 time-slot for mobile station 2.

It is to be noted that the described embodiment can be varied in many ways and that it moreover constitutes only one of a variety of possible embodiments. For instance, the presented algorithm, which supports packet scheduling decisions, is only exemplary. Also other schemes that utilize the idea of maximizing the usage of allocated interference budgets by means of using known power sequences and path loss measurements from mobile stations to base stations can be employed.

For understanding the details of the present invention, it is helpful to assume the presence of a cellular network where down-link physical connections comprise wide-band multicarrier links. The network operates with a low or unitary frequency reuse factor and no spreading or scrambling. Therefore, and especially at the edge of small cells, the throughput is interference-limited. It is also assumed that the network uses power sequences as discussed. For a given BTS having identifier i, the power sequence is expressed as Σⁱ(t)=[P₁ⁱ, P₂ⁱ . . . Pₙⁱ](1).

In Equation (1), t is the starting instance of one of the time domain and the frequency domain, and n is the number of time steps (if t is the starting instance of one of the time domain) or frequency chunks (if t is the starting instance of the frequency domain) contained in the sequence. In an OFDM system, one step can be, for example, the duration of one to a few OFDM symbols. If it is assumed that the duration of one step is the unit of time, the sequence lasts from t to t+n−1. Sequences can be slowly adapted to follow the evolution of network load, such that the sequence Σⁱ(t+n) can be different from the previous one. Directly interfering BTSs never use the same power sequence at the same time. When Σⁱ(t) starts, different UEs will experience different SNIR conditions, depending upon the power sequences of the interfering cells. It is assumed that UEs periodically measure the SNIR seen by their receivers and feed it back to the BTS. With the feedback information, the BTS can build a database of the estimated shadowing values between neighboring BTSs and UEs. Therefore, if the BTS knows the power sequences of the interfering cells, it will be able to estimate the SNIR experienced by each UE at every time instant. For MIMO systems, apart from the SNIR, the BTS will also be informed by the UE via feedback about other channel statistics (e.g., the channel practical rank estimate for every cluster of subcarriers).

The present invention proposes the use of pre-determined transmission mode sequences to maximize the throughput of networks using power sequences. For purposes of the present invention, the number of users belonging to the cell or sector i at time t is referred to as Uⁱ(t). The set of possible transmission modes for one subcarrier is referred to as M={m₁,m₂, . . . m_{K}}. If N is the total number of subcarriers, then the transmission mode sequence for user u is defined as:
Θᵤⁱ(t)={[m₁₁,m₁₂, . . . m₁ₙ][m₂₁,m₂₂, . . . m₂ₙ] . . . [m_{N1},m_{N2}, . . . m_{Nn}]}, 1≦u≦Uⁱ(t), mₖⱼεM (3)

In the case of two possible transmission modes and two possible sequences per subscriber, assume that the subcarriers are divided in groups of C consecutive elements called clusters. Every subcarrier in a given cluster has the same transmission mode. Concatenated channel coding is presumably performed along a whole OFDM symbol (or a part of OFDM symbol, or a few symbols) and, as such, is not cluster-specific. The adaptation algorithm in the BTS is designed such that it selects one of two modes for every subcarrier: \tilde{M}={mₖ,mₗ}, m≠l, 1≦m,l≦k. In this case, the possible transmission mode sequences for one subcarrier are only 2ⁿ. It is assumed that the adaptation algorithm will choose two of those sequences as follows. If θᵢ is a generic sequence built including the modes \tilde{M}, then the following is defined: Ψ={θₚ,θ_{q}}, 1≦p,q≦2ⁿ. In this case, the transmission mode sequence for user u becomes:
\tilde{Θ}ᵤⁱ(t)={σ₁,σ₂, . . . σₙ} 1≦u≦Uⁱ(t), σₖεΨ (3)

This manner of organizing adaptive transmission can lead to substantial throughput gain when compared to a non-adaptive system, while requiring only limited signaling. Assuming that \tilde{Θ}ᵤⁱ is computed at the BTS and is fed forward to the UE, the amount of signaling bits required per power sequence period is:
2·┌log₂(K)┐ bits to signal \tilde{M}
2n bits to signal Ψ
┌N/C┐ bits to signal σₖ for every cluster.

In a variation to the above, it is also possible to support more than two sequences. This implies the transmission of more than one signaling bit per cluster per adaptation period. A further variation involves the case of multiple transmission modes supported in the transmission sequences. This can be combined with the signaling of two or more transmission sequences. This assumes that the power sequence is applied at the time domain. In another extension or variation to the above, the power sequence can be applied at the frequency domain, the combination of this method with the frequency domain power sequence can result in the further reduction of signaling bits (by 2n bits in this case).

In general, the present invention can be extended using the combination of a certain number of transmission modes and a certain number of sequences. The number of signaling bits will presumably be lower when the adaptation period is short and vice-versa.

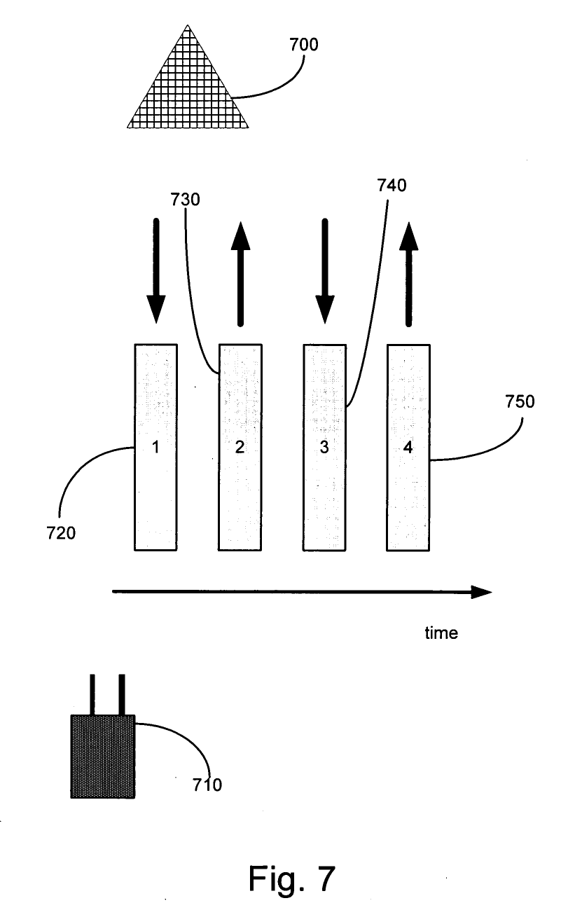

The implementation of the present invention is generally as follows. The present invention may be implemented in a cellular network where the down-link is an adaptive wide-band multicarrier link, such an OFDM link. FIG. 7 shows how down-link adaptation works for each UE. As is shown in FIG. 7, a BTS 700 transmits over a down-link a first frame 720 containing signals suitable for channel estimate. The UE 710 receives the first frame 720 and estimates channel statistics. The UE 720 feeds back via a second frame 730 over an up-link a potentially compressed version of the channel statistics estimates to the BTS 700. The BTs computes the transmission mode and feeds it forward to UE 710 over the down-link 720 with a third frame 740. In the third frames 740, a fourth frame 750, and following frames, normal down-link transmissions can start.

In a system where the length of the power sequence is n=8 steps, and one step is given by 2 OFDM symbols, each power sequence extends over 16 symbols. For an example 5 MHz channel with Nₜₒₜ=256 subcarriers, N=200 active subcarriers, clusters of C=8 subcarriers, there are a total of 25 clusters. The quantity of feed-forward signaling for adaptation in the situation of two possible transmission modes and two possible sequences per subcarrier is as follows. In this case, it is assumed that the system works with frames comprising 16 OFDM symbols, and that the adaptation cycle time is equal to 2 frames=2·16·51.2 μs=1.6 ms. It is assumed that DL is a 4×2 MIMO link using the modulation modes in Table 1 below, where the concatenated channel coding can have three different rates (e.g. ⅓, ½, ⅔).

TABLE 1
Set of Matrix Modulations Used for a 4 × 2 MIMO link

| | | | Uncoded |
|---|---|---|---|
| | Matrix | | Spectrum |
| Type of Matrix | Modulation | | Efficiency |
| Modulation | Symbol Rate | Constellations | (bits/s/Hz) |
| Diagonal ABBA | 1 | QPSK or 16-QAM | 2 or 4 |
| (diag-ABBA) with | | | |
| optimal matrix | | | |
| rotation | | | |
| Double-ABBA | 2 | QPSK or 16-QAM | 4 or 8 |
| (DABBA) with | | | |
| optimal rotation | | | |

The signaling rate is then given by:
2·┌log₂(K)┐ bits to signal \tilde{M}→8 bits
2n bits to signal Ψ→16 bits
┌N/C┐ bits to signal σₖ for every cluster→25 bits
every 1.6 ms, for a total of 30.6 kbit/s.

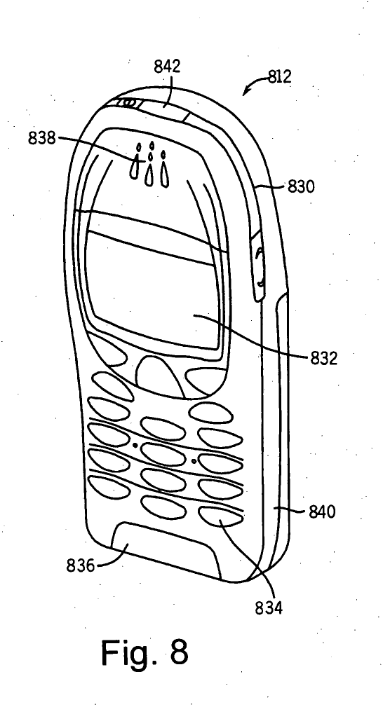

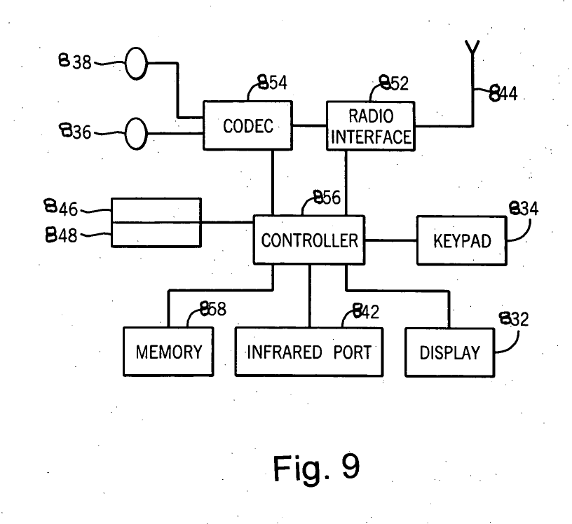

FIGS. 8 and 9 show one representative electronic device 12 within which the present invention may be implemented. It should be understood, however, that the present invention is not intended to be limited to one particular type of electronic device 812. The electronic device 812 of FIGS. 2 and 3 includes a housing 830, a display 832 in the form of a liquid crystal display, a keypad 834, a microphone 836, an ear-piece 838, a battery 840, an infrared port 842, an antenna 844, a smart card 846 in the form of a UICC according to one embodiment of the invention, a card reader 848, radio interface circuitry 852, codec circuitry 854, a controller 856 and a memory 858. Individual circuits and elements are all of a type well known in the art, for example in the Nokia range of mobile telephones. It should be noted that some or all of these components can be included either in an item of user equipment or in a base transceiver station.

The present invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method of transmitting information to user equipment over a wireless communication link, comprising:
transmitting a first frame over a downlink to the user equipment, the first frame being suitable for channel estimation;
receiving a second frame from the user equipment over an uplink, the second frame including channel estimates;
computing a transmission mode from a plurality of potential transmission modes using the channel estimates received from the user equipment, the transmission mode being computed in accordance with a predetermined transmission mode sequence; and
transmitting a third frame over the downlink to the user equipment using the computed transmission mode.

2. The method of claim 1, wherein the third frame is transmitted over the downlink in accordance with a computed power sequence.

3. The method of claim 2, wherein the computed power sequence comprises Σⁱ(t)=[P₁ⁱ,P₂ⁱ . . . Pₙⁱ], where t is a starting instance of one of the time domain and the frequency domain, and n is the number of time steps or frequency chunks contained in the sequence.

4. The method of claim 1, wherein the transmission mode sequence comprises Θᵤⁱ(t)={[m₁₁,m₁₂, . . . m₁ₙ][m₂₁,m₂₂, . . . m₂ₙ] . . . [m_{N1},m_{N2}, . . . m_{Nn}]}, 1≦u≦Uⁱ(t), mₖⱼεM, wherein Uⁱ(t) is the number of users belonging to a cell or sector i at time t, M={m₁,m₂, . . . m_{K}} is set of possible transmission modes for one subcarrier or cluster, N is the total number of subcarriers or clusters within the wireless communication link, and wherein a cluster comprises a group of subcarriers.

5. The method of claim 4, wherein the plurality of possible transmission modes consists of two potential transmission modes.

6. The method of claim 4, wherein there are two potential transmission mode sequences for each subcarrier or cluster.

7. The method of claim 4, wherein there are more than two potential transmission mode sequences for each subcarrier or cluster.

8. The method of claim 1, wherein the downlink comprises a wide-band multicarrier link.

9. The method of claim 8, wherein the wide-band multicarrier link comprises an OFDM link.

10. A computer program product for transmitting information to user equipment over a wireless communication link, comprising:
computer code for transmitting a first frame over a downlink to the user equipment, the first frame being suitable for channel estimation;
computer code for receiving a second frame from the user equipment over an uplink, the second frame including channel estimates;
computer code for computing a transmission mode from a plurality of potential transmission modes using the channel estimates received from the user equipment, the transmission mode being computed in accordance with a predetermined transmission mode sequence; and
computer code for transmitting a third frame over the downlink to the user equipment using the computed transmission mode.

11. The computer program product of claim 10, wherein the third frame is transmitted over the downlink in accordance with a computed power sequence.

12. The computer program product of claim 1 1, wherein the computed power sequence comprises Σⁱ(t)=[P₁ⁱ,P₂ⁱ . . . Pₙⁱ], where t is a starting instance of one of the time domain and the frequency domain, and n is the number of time steps or frequency chunks contained in the sequence.

13. The computer program product of claim 10, wherein the transmission mode sequence comprises Θᵤⁱ(t)={[m₁₁,m₁₂, . . . m₁ₙ][m₂₁,m₂₂, . . . m₂ₙ] . . . [m_{N1},m_{N2}, . . . m_{Nn}]}, 1≦u≦Uⁱ(t), mₖⱼεM, wherein Uⁱ(t) is the number of users belonging to a cell or sector i at time t, M={m₁,m₂, . . . m_{K}} is set of possible transmission modes for one subcarrier or cluster, N is the total number of subcarriers or clusters within the wireless communication link, and wherein a cluster comprises a group of subcarriers.

14. The computer program product of claim 13, wherein the plurality of possible transmission modes consists of two potential transmission modes.

15. The computer program product of claim 13, wherein there are two potential transmission mode sequences for each subcarrier or cluster.

16. The computer program product of claim 13, wherein there are more than two potential transmission mode sequences for each subcarrier or cluster.

17. The computer program product of claim 10, wherein the downlink comprises an OFDM link.

18. A base transceiver station, comprising:
a processor; and
a memory unit communicatively connected to the processor and including a computer program product for transmitting information to user equipment over a wireless communication link, including:
computer code for transmitting a first frame over a downlink to the user equipment, the first frame being suitable for channel estimation;
computer code for receiving a second frame from the user equipment over an uplink, the second frame including channel estimates;
computer code for computing a transmission mode from a plurality of potential transmission modes using the channel estimates received from the user equipment, the transmission mode being computed in accordance with a predetermined transmission mode sequence; and
computer code for transmitting a third frame over the downlink to the user equipment using the computed transmission mode.

19. The base transceiver station of claim 18, wherein the third frame is transmitted over the downlink in accordance with a computed power sequence.

20. The base transceiver station of claim 19, wherein the computer power sequence comprises Σⁱ(t)=[P₁ⁱ,P₂ⁱ . . . Pₙⁱ], where t is a starting instance of one of the time domain and the frequency domain, and n is the number of time steps or frequency chunks contained in the sequence.

21. The base transceiver station of claim 18, wherein the transmission mode sequence comprises Θᵤⁱ(t)={[m₁₁,m₁₂, . . . m₁ₙ][m₂₁,m₂₂, . . . m₂ₙ] . . . [m_{N1},m_{N2}, . . . m_{Nn}]}, 1≦u≦Uⁱ(t), mₖⱼεM, wherein Uⁱ(t) is the number of users belonging to a cell or sector i at time t, M={m₁,m₂, . . . m_{K}} is set of possible transmission modes for one subcarrier or cluster, N is the total number of subcarriers or clusters within the wireless communication link, and wherein a cluster comprises a group of subcarriers.

22. The base transceiver station of claim 21, wherein the plurality of possible transmission modes consists of two potential transmission modes.

23. The base transceiver station of claim 21, wherein there are two potential transmission mode sequences for each subcarrier or cluster.

24. The base transceiver station of claim 21, wherein there are more than two potential transmission mode sequences for each subcarrier or cluster.

25. A method of receiving information from a base transceiver station over a wireless communication link, comprising:
receiving a first frame over a downlink from the base transceiver station, the first frame being suitable for channel estimation;
transmitting a second frame to the base transceiver station over an uplink, the second frame including channel estimates; and
receiving a third frame over the downlink from the base transceiver station using a computed transmission mode computed from a plurality of potential transmission modes using the channel estimates, the transmission mode being computed in accordance with a predetermined transmission mode sequence.

26. The method of claim 25, wherein the third frame is received over the downlink in accordance with a computed power sequence.

27. The method of claim 26, wherein the computer power sequence comprises Σⁱ(t)=[P₁ⁱ,P₂ⁱ . . . Pₙⁱ], where t is a starting instance of one of the time domain and the frequency domain, and n is the number of time steps or frequency chunks contained in the sequence.

28. The method of claim 25, wherein the transmission mode sequence comprises Θᵤⁱ(t)={[m₁₁,m₁₂, . . . m₁ₙ][m₂₁,m₂₂, . . . m₂ₙ] . . . [m_{N1},m_{N2}, . . . m_{Nn}]}, 1≦u≦Uⁱ(t), mₖⱼεM, wherein Uⁱ(t) is the number of users belonging to a cell or sector i at time t, M={m₁,m₂, . . . m_{K}} is set of possible transmission modes for one subcarrier or cluster, N is the total number of subcarriers or clusters within the wireless communication link, and wherein a cluster comprises a group of subcarriers.

29. The method of claim 28, wherein the plurality of possible transmission modes consists of two potential transmission modes.

30. The method of claim 28, wherein there are two potential transmission mode sequences for each subcarrier or cluster.

31. The method of claim 28, wherein there are more than two potential transmission mode sequences for each subcarrier or cluster.

32. A computer program product for receiving information from a base transceiver station over a wireless communication link, comprising:
computer code for receiving a first frame over a downlink from the base transceiver station, the first frame being suitable for channel estimation;
computer code for transmitting a second frame to the base transceiver station over an uplink, the second frame including channel estimates; and
computer code for receiving a third frame over the downlink from the base transceiver station using a computed transmission mode computed from a plurality of potential transmission modes using the channel estimates, the transmission mode being computed in accordance with a predetermined transmission mode sequence.

33. The computer program product of claim 32, wherein the transmission mode sequence comprises Θᵤⁱ(t)={[m₁₁,m₁₂, . . . m₁ₙ][m₂₁,m₂₂, . . . . m₂ₙ] . . . [m_{N1},m_{N2}, . . . m_{Nn}}, 1≦u≦Uⁱ(t), mₖⱼεM, wherein Uⁱ(t) is the number of users belonging to a cell or sector i at time t, M={m₁,m₂, . . . m_{K}} is set of possible transmission modes for one subcarrier or cluster, N is the total number of subcarriers or clusters within the wireless communication link, and wherein a cluster comprises a group of subcarriers.

34. An electronic device, comprising:
a processor; and
a memory unit communicatively connected to the processor and including computer program product for receiving information from a base transceiver station over a wireless communication link, comprising:
computer code for receiving a first frame over a downlink from the base transceiver station, the first frame being suitable for channel estimation;
computer code for transmitting a second frame to the base transceiver station over an uplink, the second frame including channel estimates; and
computer code for receiving a third frame over the downlink from the base transceiver station using a computed transmission mode computed from a plurality of potential transmission modes using the channel estimates, the transmission mode being computed in accordance with a predetermined transmission mode sequence.

35. The electronic device of claim 34, wherein the transmission mode sequence comprises Θᵤⁱ(t)={[m₁₁,m₁₂, . . . m₁ₙ][m₂₁,m₂₂, . . . m₂ₙ] . . . [m_{N1},m_{N2}, . . . m_{Nn}]}, 1≦u≦Uⁱ(t), mₖⱼ]εM, wherein Uⁱ(t) is the number of users belonging to a cell or sector i at time t, M={m₁,m₂, . . . m_{K}} is set of possible transmission modes for one subcarrier or cluster, N is the total number of subcarriers or clusters within the wireless communication link, and wherein a cluster comprises a group of subcarriers.
